(19) United States
(12) Patent Application Publication
(10) Pub. No.: US 2018/0367838 A1
(43) Pub. Date: Dec. 20, 2018

(54) SYSTEMS FOR AND METHODS OF BROWSING AND VIEWING HUGE AND HETEROGENEOUS MEDIA COLLECTIONS ON TV WITH UNIFIED INTERFACE

(71) Applicant: Atriva Media Inc., Fremont, CA (US)

(72) Inventor: Wei-Jen Li, Fremont, CA (US)

(21) Appl. No.: 16/113,915

(22) Filed: Aug. 27, 2018

Related U.S. Application Data
(63) Continuation-in-part of application No. 15/406,956, filed on Jan. 16, 2017, now abandoned.
(60) Provisional application No. 62/280,983, filed on Jan. 20, 2016.

(51) Int. Cl. H04N 21/431; G06F 17/30; H04N 21/422; H04N 21/466; H04N 21/45; G06F 21/62

(52) U.S. Cl. CPC H04N 21/431; G06F 17/30056; G06F 17/30126; G06F 21/6218; H04N 21/4668; H04N 21/4532; H04N 21/42204

(57) ABSTRACT

The system and method comprise an Internet-connected defice configured to receive media files of a person from different media sources from a local network or Internet, a smart computing software, with or without hardware assist, configured to sort and categorize the media files and automatically generate a media presenting structure including one or more media channels as a primary layer and one or more media programs as a secondary layer based on an intelligent media content analysis of at least two factors. At least one of the factors includes a media content that is of the person. A display that the device is coupled to is configured to display the sorted media files on a unified user interface having the one or more media channels and the one or more media programs as a media presenting structure. A remote control is used to navigate the media presenting structure to find photos of interests on the display.

### CROSS-REFERENCE TO RELATED APPLICATION(S)

This application is a continuation-in-part application (CIP) of a co-pending U.S. patent application Ser. No. 15/406,956, filed Jan. 16, 2017 and titled, “DEVICE FOR AND METHOD OF TV STREAMING AND DOWNLOADING FOR PERSONAL PHOTOS AND VIDEOS PRESENTATION ON TV THAT SEAMLESSLY INTEGRATES WITH MOBILE APPLICATION AND CLOUD MEDIA SERVER,” which claims priority under 35 U.S.C. § 119(e) of the U.S. Provisional Patent Application Ser. No. 62/280,983, filed Jan. 20, 2016 and titled, “DEVICE FOR AND METHOD OF TV STREAMING FOR PERSONAL PHOTOS AND VIDEOS PRESENTATION ON TV THAT SEAMLESSLY INTEGRATES WITH MOBILE APP AND CLOUD MEDIA SERVER,” which are also hereby incorporated by reference in their entirety for all purposes.

### FIELD OF THE INVENTION

The present invention related to the field of multimedia presentation on television. More specifically, it's for browsing, finding and viewing personal photos and videos from huge numbers of photos and videos in media libraries across set-top box, TV-connected device, PC, media server, storage device or even cloud photo services with a unified interface.

### BACKGROUND OF THE INVENTION

People have lots of photos and videos stored everywhere such as smartphone, PC, storage device at home and cloud services or social networks on the Internet. While enjoying those photos with family at home together, people typically search the photos or videos from smartphones and cast to TV for everybody to see. The problem with casting is that you only cast one photo at a time from one person's phone and everybody else cannot see the complete collections or whole stories. People usually use voice or keyword search to find interested media from a huge library, but are only able to have limited files returned from search engine. The search results are not persistent or not able to browse further.

FIGS. 1A-1D illustrate a typical smart TV platform, such as Apple TV, which allows users to browse photo albums from TV. However, the typical smart TV platform is usually arranged in a one layer structure 102 in FIG. 1A. It is very difficult to find the right album from a huge list on the left pane. Some smart TVs, set-top boxes and streaming boxes allow users to browse the photo album from the directory structure from the physical storage like PC or other storage device. The typical TV application arranges the photos according to the names of the folders as shown in FIGS. 1B to 1D. It is very inconvenient to use with a typical TV remote control.

### SUMMARY OF THE INVENTION

In some aspects, a unified TV user interface for personal photo and video browsing in huge or deep media libraries, such as a storage in a TV-connected device, set-top box, PC or media storage in local network, or remote cloud services or social networks is disclosed. In some embodiments, the overall media libraries contain thousands of photos or videos for the whole family from many years, and users are still able to find media easily on TV. The user interface is part of the software that is able to be implemented inside TV, a dedicated TV set-top box, a storage device with TV connection, or a TV app in an existing TV connected device. In an aspect, the user interface is presented as a two layer structure having channels and programs, which are both virtual categories. The channel can be the first layer and the program can be the second layer. In some embodiments, the channel and program structure is related to where media are physically stored. In some other embodiments, the channel and program structure are not related to where media are physically stored.

Channel

In some embodiments, the channel is the top-level category that a user manually creates. In some embodiments, the channel is generated intellectually based on common scenarios or analysis from intelligence algorithms by a software. For example, users are able to manually create a “Super Car” channel, which contains all the super car photos and videos that the user collected. In some embodiments, the system creates channels based on common scenarios such as “Travel”, for media taken away from home. In some embodiments, the channels for “Event” are created by a user or by the system for photos taken in the same place within a few hours timespan (e.g., same day or within 24 hrs). In some embodiments, the channels for “Family” are created by a user or by the system for photos and videos containing faces of the family members. By using a software intelligent analysis of the media collections by face, the system is able to automatically generate a channel like “Kids” by finding all photos and videos containing children. With a similar mechanism, the software is able to identify various sorting criteria for generating various channels.

In some embodiments, the media contents that are selected are “of” the person/user or “related to” to the person/user. The factors that are used of searching, categorizing, or sorting include a weight ratio that is related to the person or user. For example, even if the user only enters “Kids” as search criteria, the software automatically uses dual factors as searching criteria including the name “John” of the user (e.g., by comparing/matching voice fingerprint to identify that it is John providing the search input) and “Kids” for searching the media collections. As such, the software will have a search code as (INPUT=SEARCH “JOHN” and “KIDS.”) In another example, the relationship is also included in the search command, such as (INPUT=SEARCH “JOHN'S KIDS.”) The weight ratio can be based on the importance or closeness of the relationships. For example, for a search of the term “Kids,” the search weight ratio can be 100% when only one kid that is John's kid is in a photo. The search weight ratio can be 70% when there are John's kid and another kid that is not John's kid in the photo or video. The media content (e.g., the photo, sounds, or video) can be categorized and/or sorted (e.g., category, types, or presenting priority) based on the scores or numbers of the weight ratio.

When the software (e.g., smart computing system or device that installed the software or smart software) learns that John Hack has two kids (e.g., from FACEBOOK®'s face and relationship tagging) as Peter Hack and Kevin Hack. The software can use various social media or online search engines to automatically identify various personal relationships. For example, the software can automatically generates two Programs as “Peter Hack” and “Kevin Hack,” which are the subset/secondary tier of the structure within the channel (e.g., first or primary tier) of “Kids” or “John's Kids”. In some embodiments, the software obtains the user's permission to create the new programs of “Peter Hack ” and “Kevin Hack.”

In some embodiments, the software uses its intelligent analysis of the media collections by location. The system automatically generates a channel like “Asian Travel”, which contains photos taken from Asian cities. By intelligent analysis of the media collection by theme, the system can automatically generate a channel like “Water Sports” for those photos containing swimming pool or beaches. Above are some examples of channel characterization, and other types of channels are within the scope of the present disclosure.

In some aspects, the channels are obtained from the cloud services. For example, if a user grants access to their FACEBOOK® page, the system is able to create a “Facebook” channel containing all photos the user posted on FACEBOOK®. Similar mechanisms are applicable to other social media, websites, or smart phone APPs, such as YOUTUBE®, INSTAGRAM®, or FLICKR®.

In some aspects, the system generates a personalized and unique channel list based on the photos and videos from their own media libraries. It is also unified since users can see all their media collections in one user interface (e.g., on TV). Unified media browsing interface for all cloud accounts (YOUTUBE®, INSTAGRAM®, or FLICKR®, GOOGLE® Photos) and local storage in the TV, set-top box, PC or storage device in the same local network.

In some embodiments after the channels are created, automatically or manually, the contents in the channels are not static and are able to be dynamically updated. The contents in the channel are able to grow over time when new photos or videos meet the criteria of the channels. In some aspects, the channels are deleted, renamed or shared to other people.

Program

In some embodiments, the program is set as a second-level category, in which the system is able to generate the program automatically based on the characteristic of the channel. For example, the photos in the “Event' channel will be arranged by date/time of the event. The photos in the “Asian Travel” channel will be arranged by location of the photos taken.

In some aspects, unique channel and program arrangement are based on media metadata, such as date/time, location, theme (outdoor, indoor, nature, party, water/ocean, etc), device type (SLR, smartphone, action camera, security camera) and are able to be also based on the storage places, such as some cloud storage or services.

In some embodiments, the channel and program structure are mainly designed to be presented on a TV screen, since most of the TV has resolution of 1280×720 (720p) or more with horizontal layout. It is an advantageous feature to display channels on the side of the screen, but still have plenty of space in the center for displaying multiple program thumbnails, which are still able to be seen clear with size of 300×200 pixels or more. In some embodiments, the channel and program structure are used in smaller screens, such as smartphones or tablets, with a different layout. In some embodiments, the software disclosed herein is able to take/sample only a portion (e.g., 1/10-1/1000 of the original file) of the media content (e.g., photo and video) and display as thumbnail or smaller (e.g., less pixels or less resolution) of a photo on the TV, so that that the software does not need to download the entire media content to be displayed.

In some embodiments, the system includes a touch-based remote control (e.g., a device) to easily browse and find specific photos from various channels and programs and even enjoy it as a full-screen mode, because the TV is typically big and far away from where the users sit. With two layers of structure (e.g., channel and program), a user can easily find any photos from thousands of photo and video collections. In some aspects, the touch-based remote control is able to be implemented as an app in a smartphone or dedicated hardware with touch screen display.

In some embodiments, the screen in the remote control is changed along with the TV screen, concurrently or with some time shift. When the TV screen is showing the “channel view”, which contains a list of channels and programs from the current selected channel, the remote control displays the similar layout so when the user scrolls, selects or presses the UI on remote and the TV reflects such change accordingly. When the TV enters the “program view”, which shows the photos within a program. The remote screen shows the similar layout and allows users to go to the previous or next program, play slideshow or show particular photo on full-screen.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout. FIGS. 1A-1D illustrate a typical TV program guide.

FIG. 2A illustrates a unified user interface for receiving media from multiple media sources in accordance with some embodiments.

FIG. 2B is a flow chart showing the key components of the UI and its operating method in accordance with some embodiments.

FIG. 3 is a flow chart showing how the channels and programs are generated in accordance with some embodiments.

FIGS. 4A and 4B illustrate a manual or automatic media arrangement system for channels and programs within a channel in accordance with some embodiments.

FIGS. 5A and 5B illustrate a dynamic media arrangement system for programs and photos within a program in accordance with some embodiments.

FIGS. 6A and 6B are illustrative screen shots of programs by channels in accordance with some embodiments.

FIGS. 7A and 7B are illustrative screen shots of media/photo thumbnails within a program in accordance with some embodiments.

FIGS. 8A and 8B are illustrative screen shots of programs by channels in accordance with some embodiments.

FIGS. 9A, 9B, 9C and 9D are illustrative screen shots full-screen media/photos with various levels of details from media meta-data or intelligent analysis in accordance with some embodiments.

FIG. 10A illustrates a mobile control of the user interface in the channel/program view in accordance with some embodiments.

FIG. 10B illustrates a use case of the mobile control including program, photo thumbnails and media control in accordance with some embodiments.

FIG. 11 illustrates a dedicated hardware remote control in accordance with some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

There are so many typical Smart TVs that are Internet connected or TV connected streaming devices that allow a user to watch Internet contents on TV. Better improvement of the image and video presentation and control are needed. It is still inconvenient to use the typical media presentation devices and method today. For example, when people want to show photos or videos on TV, usually they need to use different devices, software, or mobile APP in order to find the photos stored in different places. For example, when a user wants to show a picture from a PC in the home network, they need to use a DLNA compatible TV or streaming device to find a picture from a PC with compatible software running as media server. When a user wants to show a picture from Google Photos, the user needs to open the APP on the mobile device and cast it to the TV, one photo at a time.

In the following, some exemplary embodiments are disclosed. A Unified User Interface (UUI) with the video and photo presentation methods in accordance with some embodiments are able to be implemented inside a TV, a TV streaming device or any TV connected hardware that can also connect to user's home network and Internet. In some embodiments, a unified user interface is provided that not only allows users to browse and find photos and videos stored in any devices, but also in an organized way in a channel and program structure, which a user can manually arrange as well as taking advantage of state-of-the-art computer vision algorithms and software to automatically arrange for the user.

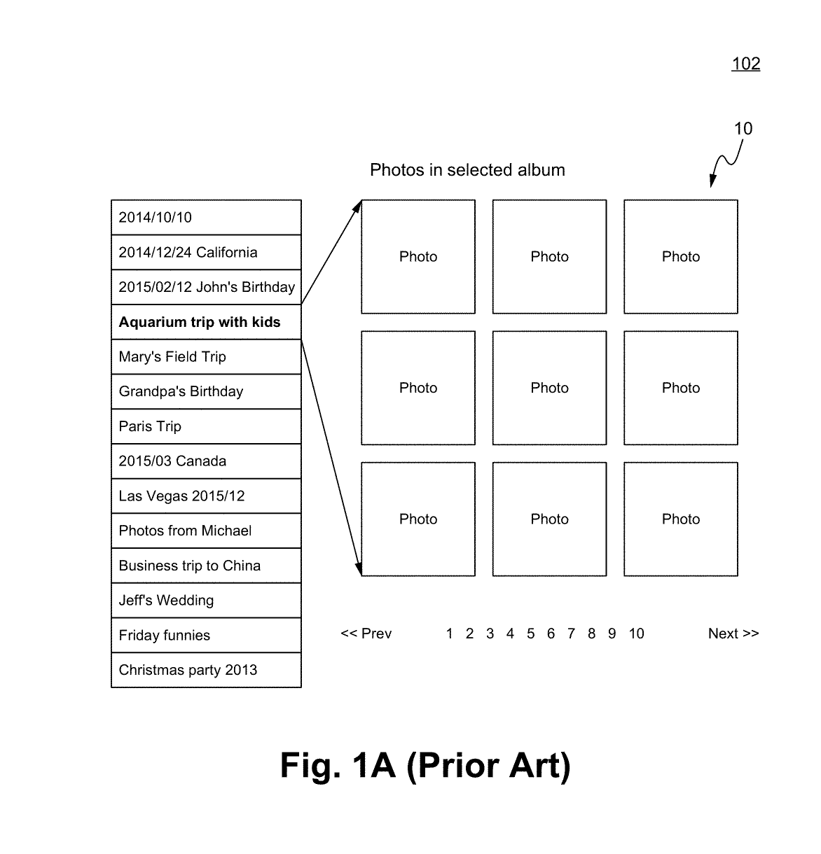

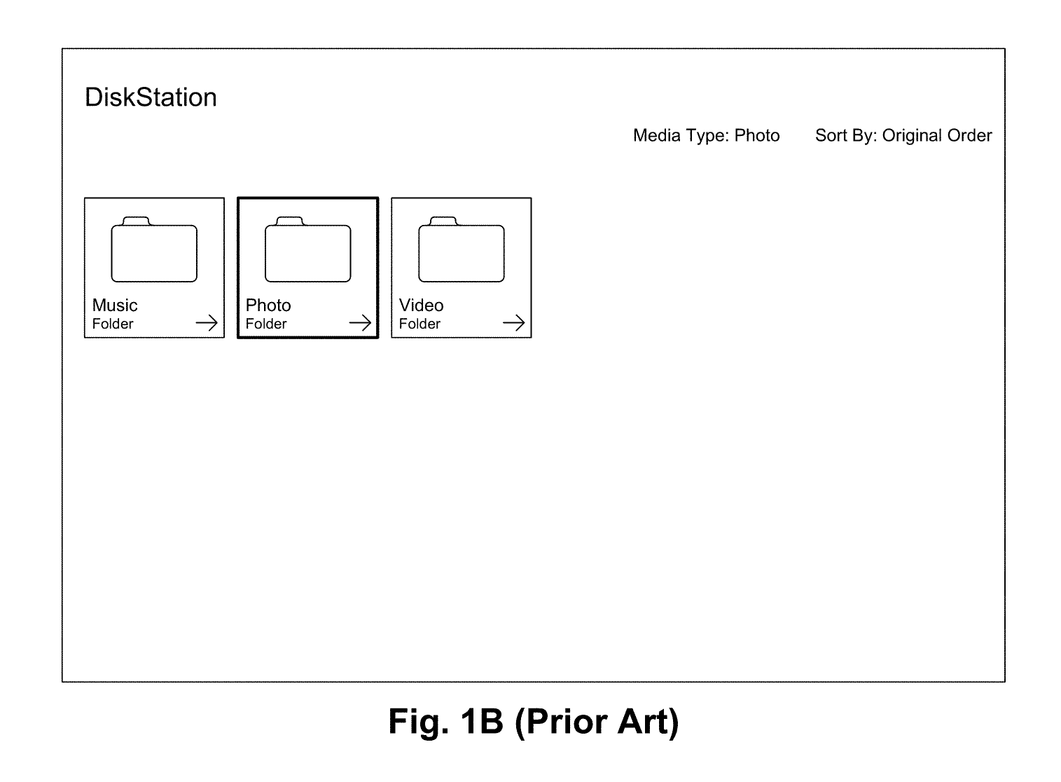

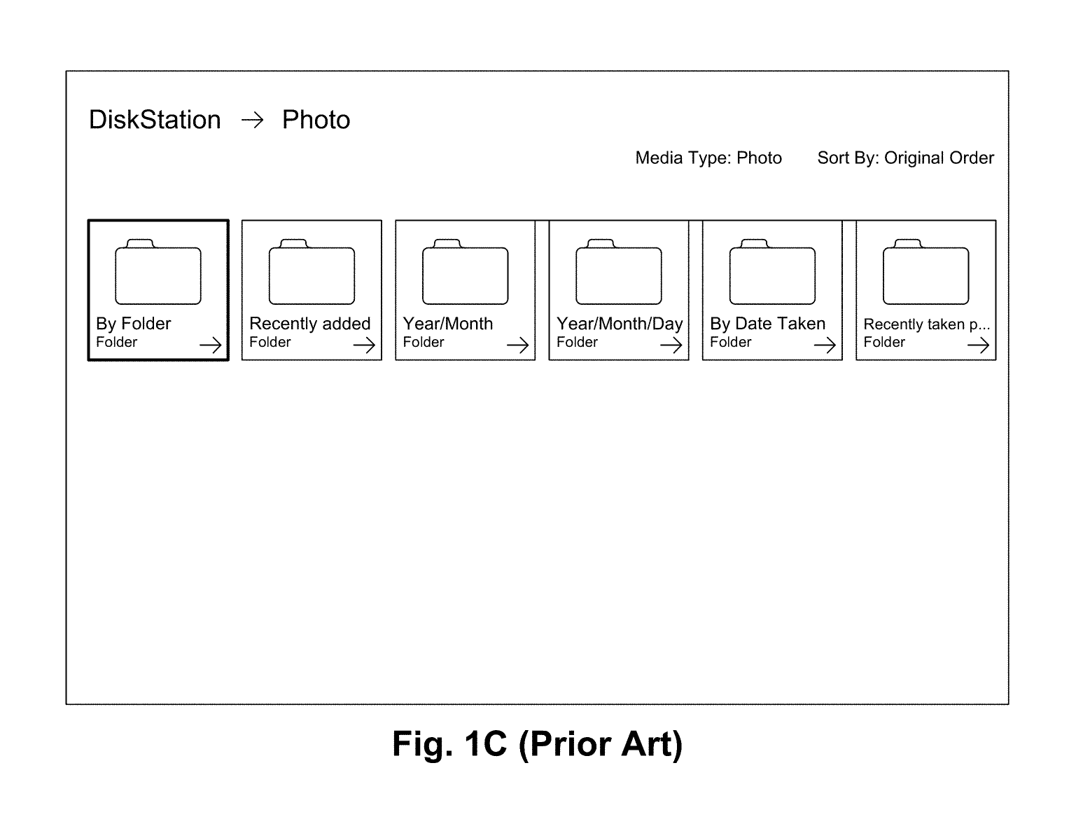

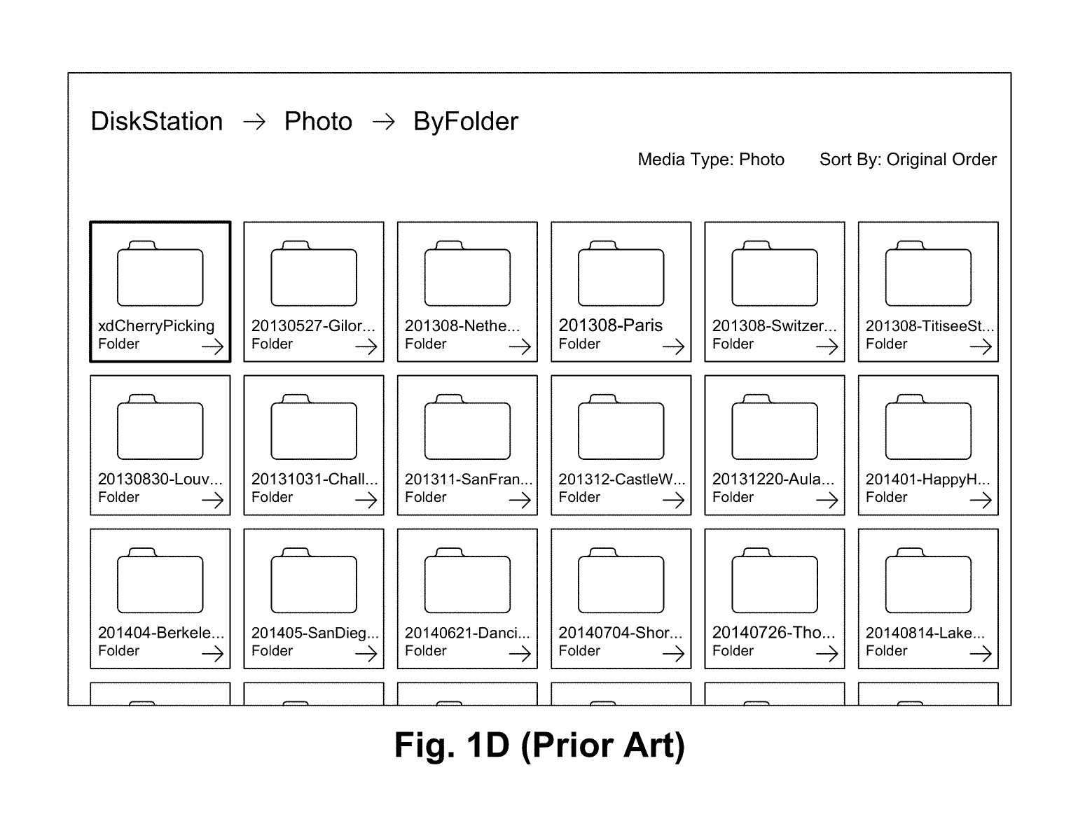

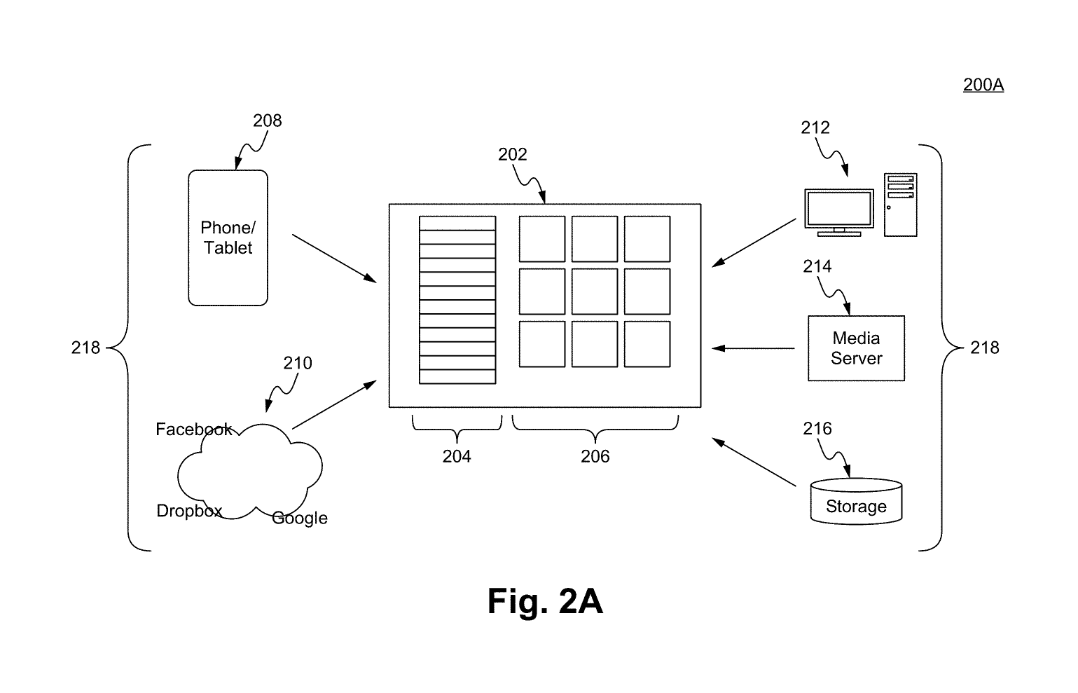

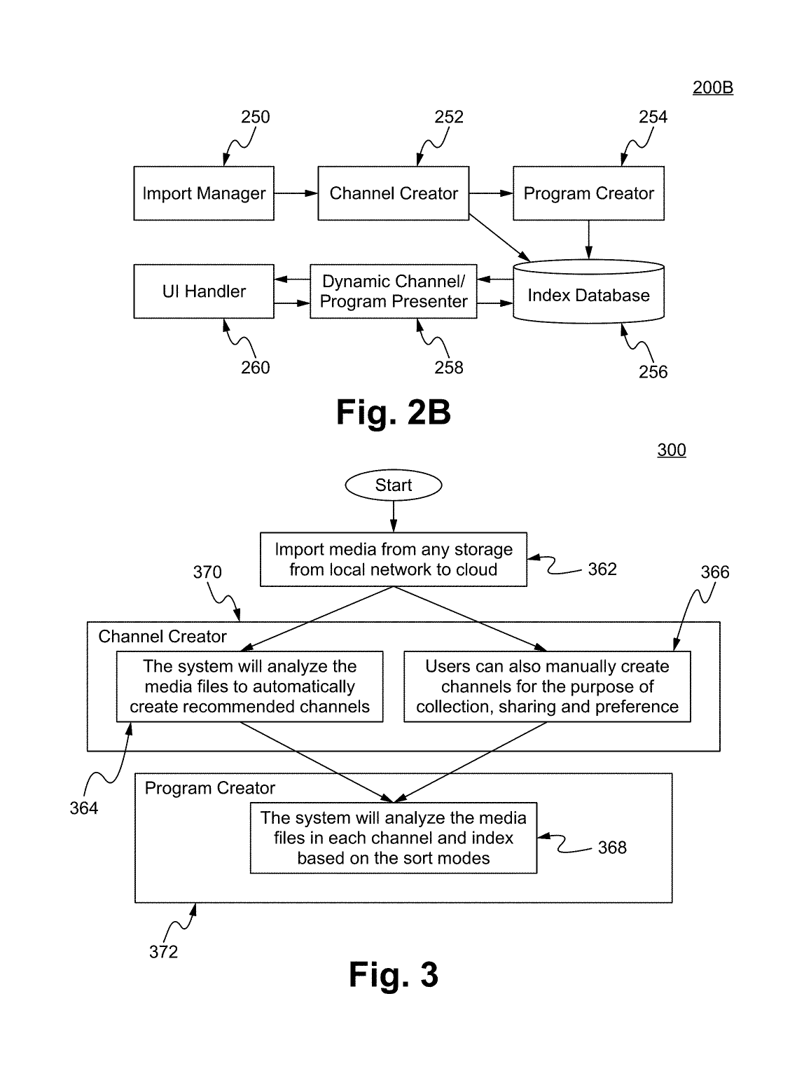

FIG. 2A illustrates a user interface 200A for receiving media from multiple media sources in accordance with some embodiments. There are many sources for the personal photos and videos (e.g., one or more media storages 218) where people store their personal photos and videos (e.g., media) including a PC 212, a media server 214, storage devices 216, smartphones 208, and cloud services 210, such as social media (e.g., FACEBOOK®), online storage service (e.g., DROPBOX®), and online search engine and personal activity services (e.g., GOOGLE®).

In some embodiments, a UUI 202 (e.g., a Unified User Interface) comprises channels 204 and programs 206, which pull and gather photos, video, and other media from the various sources described above to the UUI 202. In some embodiments, the UUI 202 comprises stored credentials or passwords for automatically accessing or maintaining the accessibility to various devices and services, such as FACEBOOK®. In some embodiments, the UUI 202 automatically negotiates or exchanges credentials or accesses with various media storage 218, so that the UUI 202 can access the media and requests the media to be downloaded, displayed, or streamed to the UUI 202. Using the UUI 202, the users do not need to use many different APPS and different configurations and do not need to manually connect cables from a particular device to TV and display when people want to share photos from these devices to TV in front of the whole family.

FIG. 2B is a flow chart 200B showing the key components of the UUI 202 of FIG. 2A and its operating method in accordance with some embodiments. At a step 250, at the time when the user imports the media to the system, the “import manager” is handling the media retrieval from any source. At a step 252, the “import manager” passes along the media info to a “channel creator”. After the step 252, the process can go to a step 254 for program creating or to a step 256 for indexing database. At the indexing database, the media contents are selected, categorized, prioritized, and/or sorted. In some embodiments, the index database at the step 256 determines whether to further download a media content file, and subsequently notify the Import Manager to re-download a file, to delete a file, to continue downloading a file, and/or sharing a file. The “import manager” stores and allows a user to provide login credentials or a secret password to access any media source regardless of whether or not it is local on the device, in a home or local network, or on the Internet.

At a step 256, the “channel creator” uses a built-in intelligent media indexing service to analyze the photo or video contents and its corresponding metadata, along with other media files coming along with this media file. For example, all photos taken from a party event contains similar people and took place at the same location within a few hours timespan on the same date. Then the system can decide to include all these photos or videos in the “Event” channels. In another case, when the user imports the casual family photos at home, the system can recognize the family member with face recognition technologies and determine that these photos should go to a “Family photo” channel. In another example, if the imported photos are taken in some tourist locations, the system will find all related photos and videos taken in a few days span in the nearby areas, and decide to put them into the “Travel” channel.

At the step 254, the “Program Creator” starts to sort all the media in a channel with a few meaningful sorting mechanisms, such as date/time, location, people, theme, etc. The reason for several different sorting mechanisms is that each sorting mechanism is able to make the sorting more useful and easier to use/view for the users and audience when the media are collected in one channel rather than sorting them when all the uncategorized media are gathered, which is able to save computing time or speed up the computing efficiency by grouping first and then sorting in that group.

In some embodiments, the system determines the appropriate sorting methods, but a user can change it or override it from the UUI when they want to sort in the other ways. When the user requests the sorting method changes, the UUI is able to respond immediately since all the necessary metadata generated by the “Program Creator” and “Channel Creator” are stored locally in the “Index database” so the system does not need to sort all the media in the storage on the fly since the media may not be able to access if they are stored in the Internet. In certain scenarios, the full resolution of the media is not needed, since the display can have much less resolution than the original media. While retrieving necessary channel and program indexes from the local database and the smaller resolution media from the original storage location, the user can easily browse and find the favorite media from huge media libraries across multiple storages easily.

At a step 258, the “Dynamic Channel/Program Presenter” (the “presenter”) is the module to compose the channel and program on TV screen based on user's input from “UUI handler” (the “handler”). At a step 260, the “UUI handler” takes the user input from a remote App or hardware remote device to inform the presenter which channel and program to show, and the presenter pulls the actual media information out of the database and also retrieves the media itself from the original storage and composes them on the TV screen. The term UUI or UI used in the present disclosure is able to also include the backend operating systems, devices, processes, and methods. For example, although the term UUI or UI is used, it can also include the hardware and software that are needed to perform such action, including a hard drive, a CPU, a memory, and software/intelligent software programs.

The UUI handler takes the user input for channel selector, channel scrolling, program selector, sorting changes, and media playback. The system includes the remote control design to all faster scrolling on channels and programs from huge media data libraries across multiple places.

FIG. 3 is a flow chart 300 showing how the channels and programs are generated in accordance with some embodiments. At a step 362, the user imports the media from any storage to the system through the network, physical connections or any other means. At a step 364, the “Channel Creator” 370 automatically analyzes the contents to determine if the imported media files can be put into any existing channels or a new channel.

For example as shown in the step 364, if there is an existing “Travel” channel, when user imports media files taken from a recent vocation, the system can automatically import them to the existing “Travel” channel because it met the criteria of the “Travel” channel. On the other hard, if the “Travel” channel does not exist before the import, the system will automatically recommend a new “Travel” channel to keep these media files. The UUI is able to inquire or receive channel and program information from other connected or related device or services for its own use.

At a step 366, the user can also manually create their own media channel for their own media collections for their specific purpose. The user can also specify the criteria for the channels so all future media meeting the criteria, will be included in the media channels as well. The UUI is able to inquire or receive channel and program information from other connected or related devices or services, for how others are manually creating their channels and systems, so that the UUI can use that information to automatically create the same or similar structure therewithin.

At a step 368, the “Program Creator” analyzes all media in each of the channels and creates many sorting mechanisms. For example, the “Travel” channel is able to have the default sorting method as “Location,” since usually there are many photos taken in one place and move on to the other place. A user is able to change the sorting methods to “Date/Time” if they remember the time when they visited a particular place. In another case, the default sorting method is able to be “People” for the “Family Time” channel. Since most of the photos in this channel can be taken at home so the user may want to see the picture of the particular family member as a group. When the photos of a particular person are grouped together, the user may easily see how the person grows if they are a child.

Sorting Criteria

In some embodiments, the sorting criteria comprise dual factors for sorting and/or categorizing. In some embodiments, the sorting criteria contains “of the person”, such as “personal,” “his/her personal effect,” or “related to the user.” Various degrees or weight factors of the person can be used. In one example, “of the person” is set as a default factor. When a user inputs “travel” as a search or sorting criteria, the device and system disclosed herein search both “related to the user” and “travel” dual factors. In use, the user input “travel this year” as a sorting command, the system and device disclosed herein search photos and/or videos that are taken while travel or related to travel in this year and also only photos that are related to the user himself/herself. In other words, photos and videos that are in the news report not related to the user are not selected or sorted. In some embodiments, the factor “relating to the user” is shown to the user or viewer. In other embodiments, the factor “relating to the user” is concealed or not revealed to the user or viewer. In such an example, since the system actively does not select, delete/remove, skip the media files that are not related or have a low relevance (e.g., weight factor less than 30), the computing device is able to categorize or sort in a more efficient way, which saves computing resources.

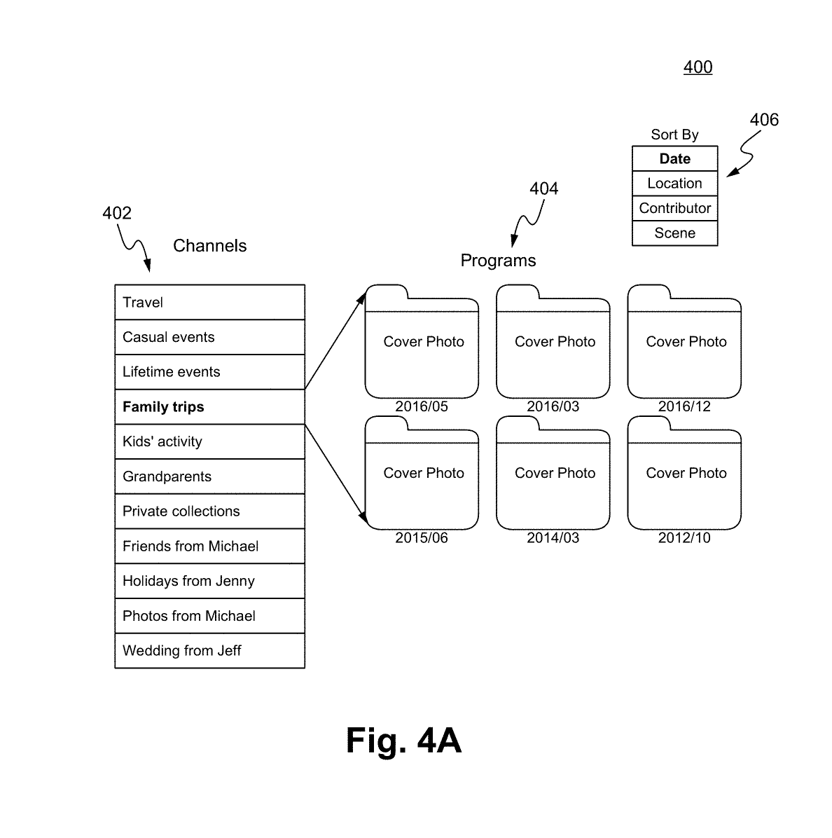

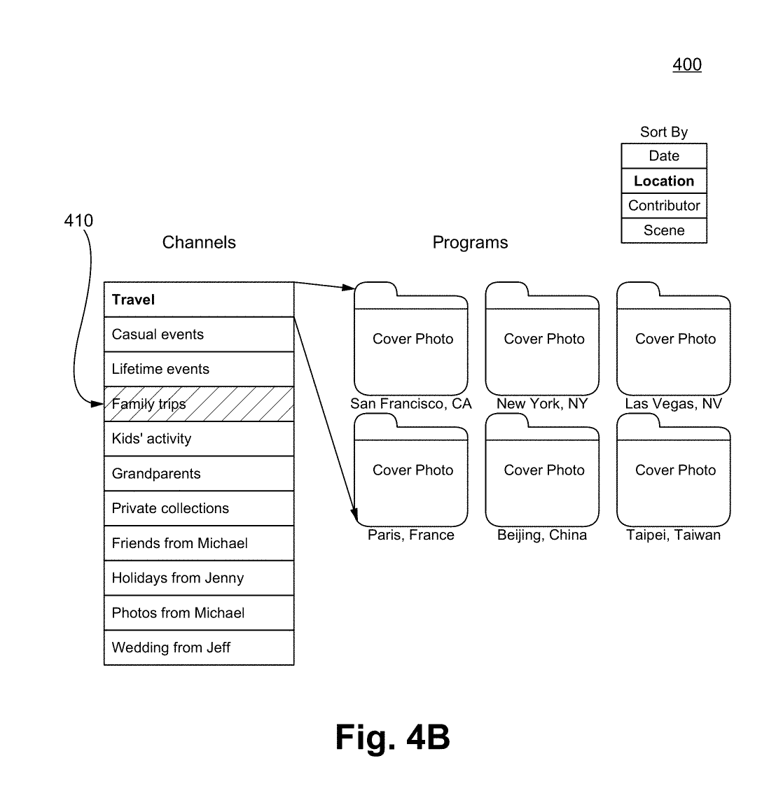

FIGS. 4A and 4B illustrate a manual or automatic media arrangement system 400 in accordance with some embodiments. The system 400 is able to create/sort media channels 402 manually or automatically. The search method and criteria is able to include or combine with the “of person” factor as described above, which is a form of dual searching factors.

In some embodiments, the media is structured to be selected and stored in channels 402, as a method of sorting different media of different characteristics into various channels. In the channels, the media are further sorted into programs 404, which are media (e.g., photos, sound, and video) of the same category and/or characteristic.

In some embodiments, the channels 402 are able to be sorted by categories, collections, and live streams. In some embodiments, the channels are categorized and created by user-specific topics, including “Travel,” “Family,” and “Events” as family activity related. In some embodiments, the media are categorized into one or more specific channels when one or more characteristics are detected or found. For example, in a “Kids” channel, photos containing young kids and/or toys are characterized as photos in the “Kids” channel, which can be selected, sorted, and categorized along with the personal factors.

In some embodiments, the characteristics are identified automatically, such as using a face identification software, an object identification software, a graphic analysis software, a content analysis and image captioning software, and/or the metadata. The metadata can include technical metadata, descriptive metadata, and administrative metadata. In some embodiments, the descriptive metadata comprises captions, headlines, titles, keywords, and location of capture. In some embodiments, the types of the metadata include IPTC-IIM, IPTC Core & Extension, PLUS, XMP, EXIF, and Dublin Core. Using the metadata, the media is able to be attributed to or characterized with one or more specific characteristics. For example, when the location of a photo stored in the metadata is not the place of a usual visit or with personal effects, such as home, office, or frequently visited restaurants, the photo is able to be tagged or characterized as a traveling photo or a candidate for a traveling photo.

In some embodiments, the identification of the characteristics is performed manually. A user is able to enter the characteristics of the photo by verbally or typing. In some embodiments, a user is able to enter the characteristics for the first few photos, and machine learning is used to automatically identify the persons, objects, or locations in the photo through the similarity of the objects (e.g., >65% of image similarity) or recognizable patterns.

In some embodiments, if the location of the photo taken is beyond a predefined distance from work or home, the photo is tagged or characterized as a travel photo or a candidate of the travel photo. In some embodiments, the GPS location of where the photo is taken is determined as one of popular sites for visitors or the image is determined as a famous object or landmark (e.g., the Golden Gate Bridge), the photo is tagged or characterized as a travel photo or a candidate for a travel photo.

In some embodiments, the media for the “family” channel is able to be determined by a user's definition via a relationship input. In some embodiments, the family relationship is learned by the device or the cloud server via other connections, such as the photo labeling functions on Facebook®. Any methods and mechanisms that are able to be used to identify the relationships between the device user/owner and the person in the media are within the scope of the system herein.

In some embodiments, the media for the “events” channel is able to be determined by location, time, person or content of the image, or a combination thereof of the photo/media is taken. For example, the GPS location recorded as Liberty Island of New York is able to be determined as a vacation or sightseeing event for the event channel. In another example, when the recording time of a photo is taken during the day that the user's calendar is marked as son's birthday or when the photo is analyzed with a birthday cake, the photos are tagged or attributed as birthday photos.

In some embodiments, the channels function as dynamic or living storage. Users are able to continuously update photos that have similar characteristics for the specific channel. In some embodiments, the photos or media are automatically assigned one or more characteristics based on the above detectable characteristics (e.g., the GPS location), so that the photos and media are automatically grouped/stored with the photos and media with the same or similar characteristics. In some embodiments, a user is able to browse the photos and media as the channels in a TV program guide. In some embodiments, the system is configured to automatically organize into “programs” or “albums” based on the sorting methods, including dates, locations, contributors, and scenes. In some embodiments, the users manually create “programs,” which are used as channels. In some embodiments, each of the programs is a collection of photos that contain information matches one or more of the sorting criteria (e.g., the characteristics). In some embodiments, each of the programs is dynamically generated, such that the users do not need to manually update the programs.

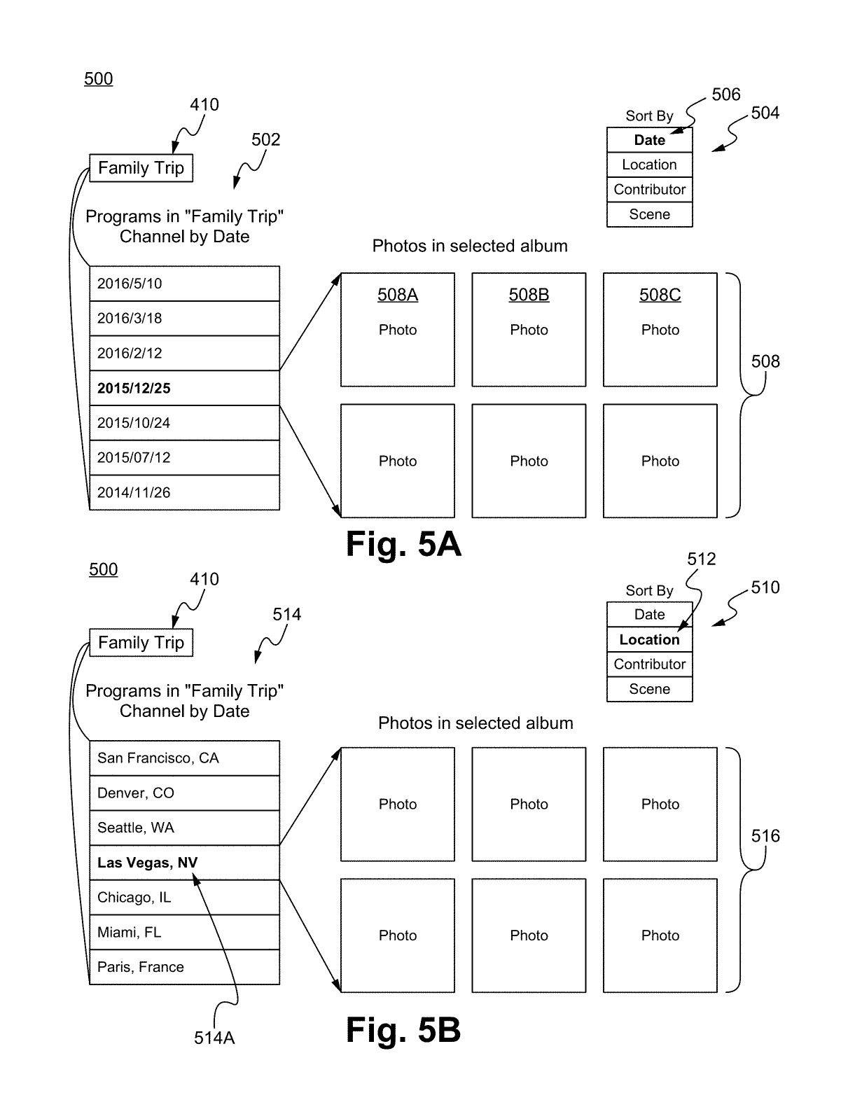

FIGS. 5A and 5B illustrate a dynamic media arrangement system 500 in accordance with some embodiments. The system 500 is able to create/sort media programs dynamically, wherein the media are sorted based on various dynamic factors, such as surrounding listed/displayed media, user's input, and search key words.

FIG. 5A illustrates that the media arrangement structure 500 (e.g., program or channel) is created based on the date. In some embodiments, a user selects the “date” 506 as the sorting method in the sorting method box 504. Available media/photos at different dates are listed in the scrollable box 502. When a specific date is selected in the scrollable box 502, the photos or media (e.g., video or sound recording) are presented in a matrix 508, which is similar to a TV show program selectable by the user. In some embodiments, the matrix 508 is scrollable up and down, so that more photos are able to be loaded like a wheel in a continuous and non-stop manner In some embodiments, the matrix 508 is loaded with one new row at a time to replace a row that was presented. In some embodiments, the matrix 508 is loaded with one new page at a time to replace an entire page of photos or media that were presented. In some embodiments, the matrix 508 is loaded with one new photo or media at a time to replace a single photo or media that was presented. The new photos or media to be presented are able to be selected based on various criteria, such as the degree of relevance of the surrounding photos or media. For example, when the photo 508B is selected to be replaced, the system 500 is able to replace the photo 508B based on the related content of the images of 508A and 508C. In an example, when the photo 508A shows a California scene and the photo 508C shows an Oregon scene, the photo 508B is able to be selected with a location close to California and Oregon, such as a scene of Nevada.

Using the system 500, the numbers of photos and media that are needed to be loaded into the computing memory are reduced, since pre-qualified photos and media (e.g., matching the sorting/attributing criteria) are reduced. Such advanced features enhance the computing efficiency and computing speed by narrowing down to less qualified items to be read and/or loaded.

In one example, when “Family Trip 410” in FIG. 4B is selected. The program 502 with “date” as the sorting criteria is listed. When the “date” is chosen or selected, the photos 508 in the program 502 are displayed.

FIG. 5B illustrates that the media arrangement structure 500 (e.g., program) is created based on the location. In some embodiments, the location information is obtained through the geo-location information from a built-in GPS of the image/media acquiring device (e.g., a smart phone). In some embodiments, a user uses a remote (e.g., an infrared remote control; a TV remote control) to scroll up and down the sorting menu 510 and selects a “Location” based sorting selection 512. The selection 512 makes the channels 514 display locations of the photos and media that are acquired. For example, if the user selects “Las Vegas, NV” 514A, the photos that are taken at Las Vegas are displayed at the album area 516.

In some embodiments, the sorting methods of the system 500 use various sorting factors (e.g., priority), processes, criteria, and/or characteristics. For example, the sorting of the photos and media is able to be done based on “contributors,” “devices,” “scenes,” and any other sorting criteria. In some embodiments, the system 500 sorts the photos and media based on “contributors,” which is a sorting method based on the owner of the photos. For example, the system sorts the photos according to the alphabetical order of the last name of the photo owners. In some embodiments, the sorting method of the system 500 sorts the photos and media using “devices” as the sorting criteria. The photos in the system 500 are able to be a collection of photos and media from various devices (e.g., smart phone, notebook computer, and tablet). The system 500 is able to sort the photos and media based on the source of the devices.

In some embodiments, the sorting method of the system 500 is able to automatically detect the scenes in the photo/media and arrange the photos and media based on the scenes detected. For example, the scenes detected can be beach, sky, building, people, animal, and sunset. In some embodiments, each of the photos or media is only attributed to one of the characteristics, so each of the photos or media will only appear in one channel or be attributed to one characteristic. In the above case, only the most highest priority or highest relevance tag or characteristic is used as the sorting criteria. In some embodiments, multiple characteristics are used as factors in deciding/factoring which channel or channels that the photo or media should be attributed to.

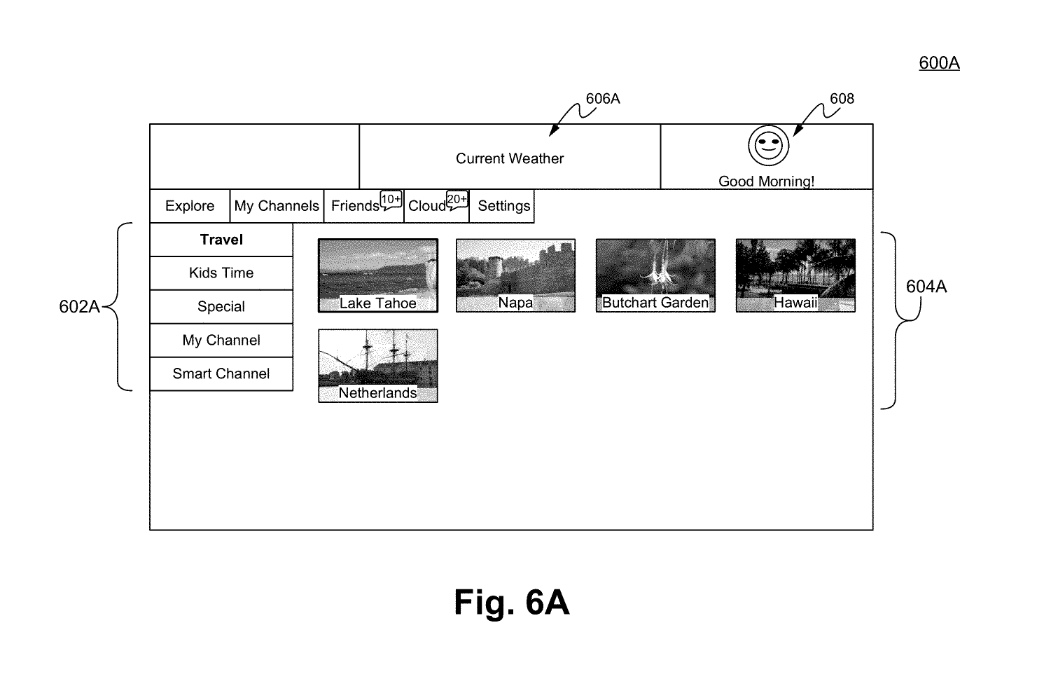

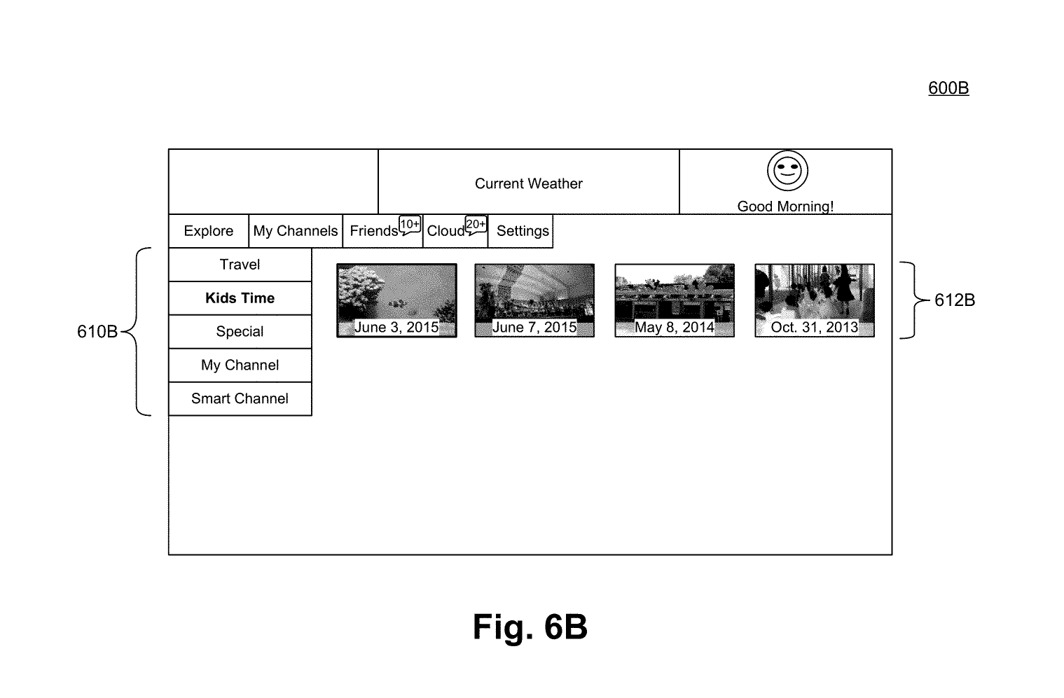

FIGS. 6A, 6B, 7A, 7B, 8A, 8B, 9A, 9B, 9C and 9D are illustrative screen shots of media/photos by channels in accordance with some embodiments. FIG. 6A illustrates a media presenting system 600A based on type of media 602A, including travel, kids time, special, my channel, and smart channel. The media associated with the selection (e.g., travel) are presented in a grid matrix at the media displaying area 604A. The system 600A is able to include a dynamic information area 606A and account info 608A.

FIG. 6B illustrates a media presentation of kids time, which is presented based on the time stamp 612B in the channel of “kids time” 610B. The media in the channel are arranged based on the sorting selection, such as time, location, events, and contributors.

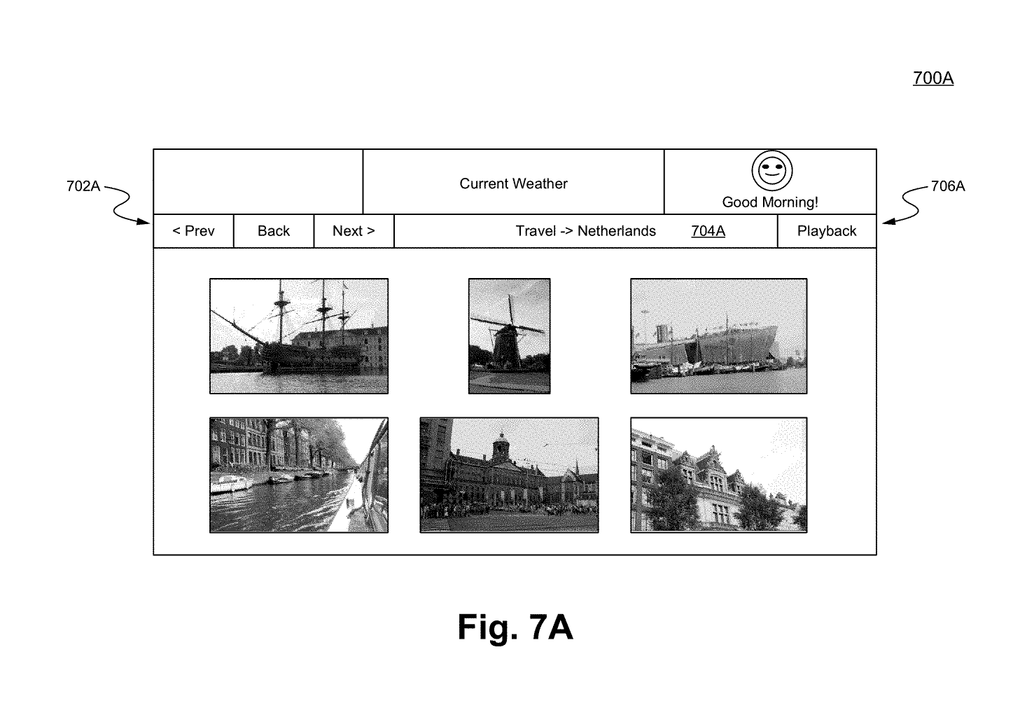

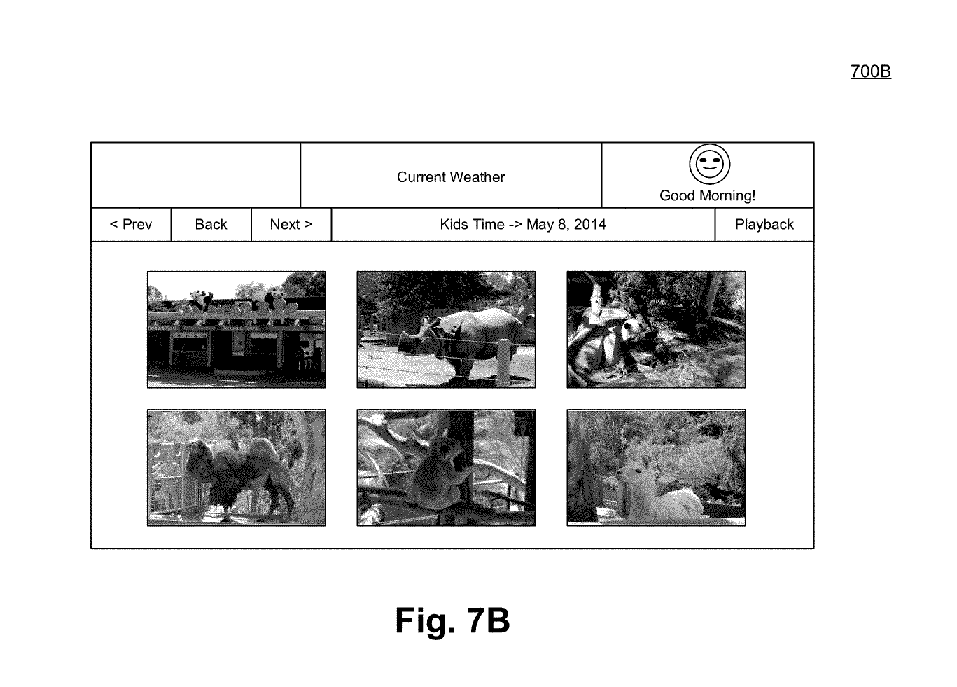

FIG. 7A illustrates a media presentation sorting system 700A, which is based on a sorting criteria of location. The system 700A includes a play control 702A, channel information 704A, and playback button 706A. A user is able to scroll through photos or media up-and-down and left-and-right using a controlling device, such as a TV remote control.

FIG. 7B illustrates a media presentation sorting system 700B, which is based on a sorting criteria of photos relate to kids' activities. In some embodiments, each of the photos or media are able to be individually selected to be displayed in a full screen, slide show, or video playback.

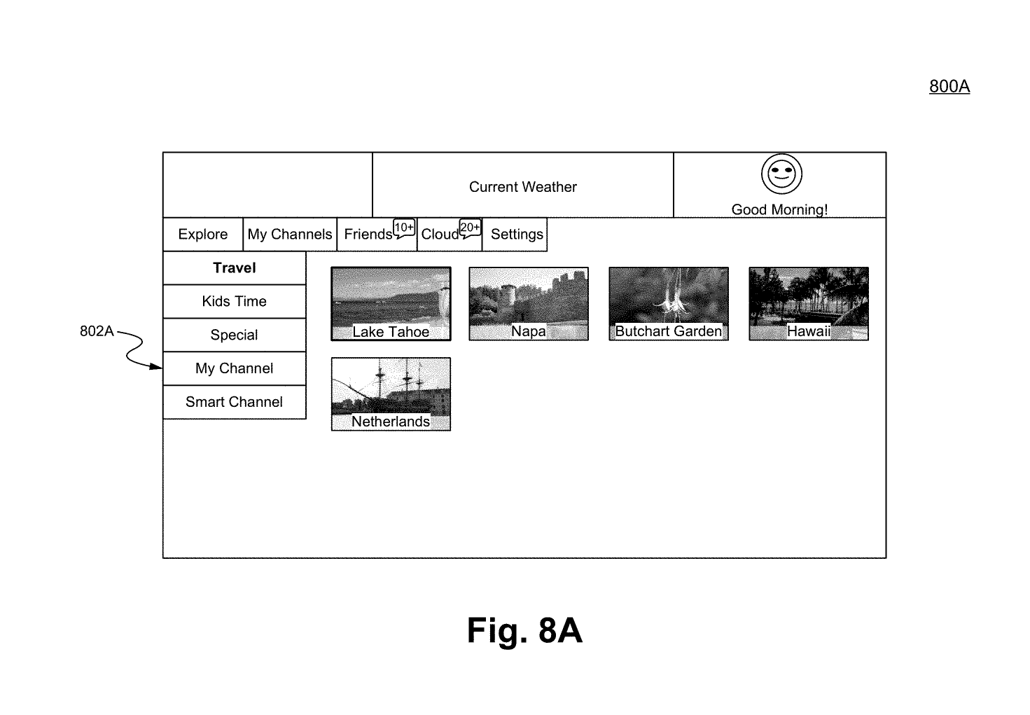

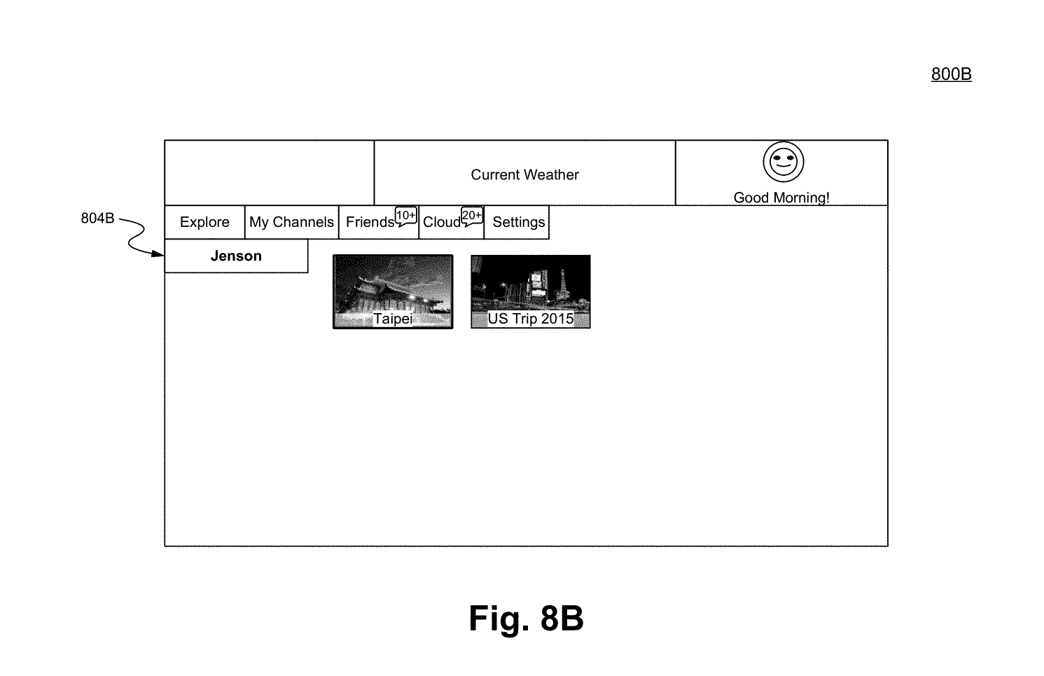

FIG. 8A illustrates a media presentation sorting system 800A, which is based on a user created channel 802A. FIG. 8B illustrates a media presentation sorting system 800B, which is based on a shared channel 804B, which is able to be from a connected friend or from any other users. In some embodiments, the channels inside the “Friends” tab in the top menu are shared from other people. The channel is the basis unit for sharing. When a channel owner shares a channel to other users using the same software system, all contents within the shared channel are able to be viewed from other user's TV regardless where the contents are in the channel owner's home or cloud storage. This allows remote friends and families to access your personal media channels in the same unified interface as their own media channels.

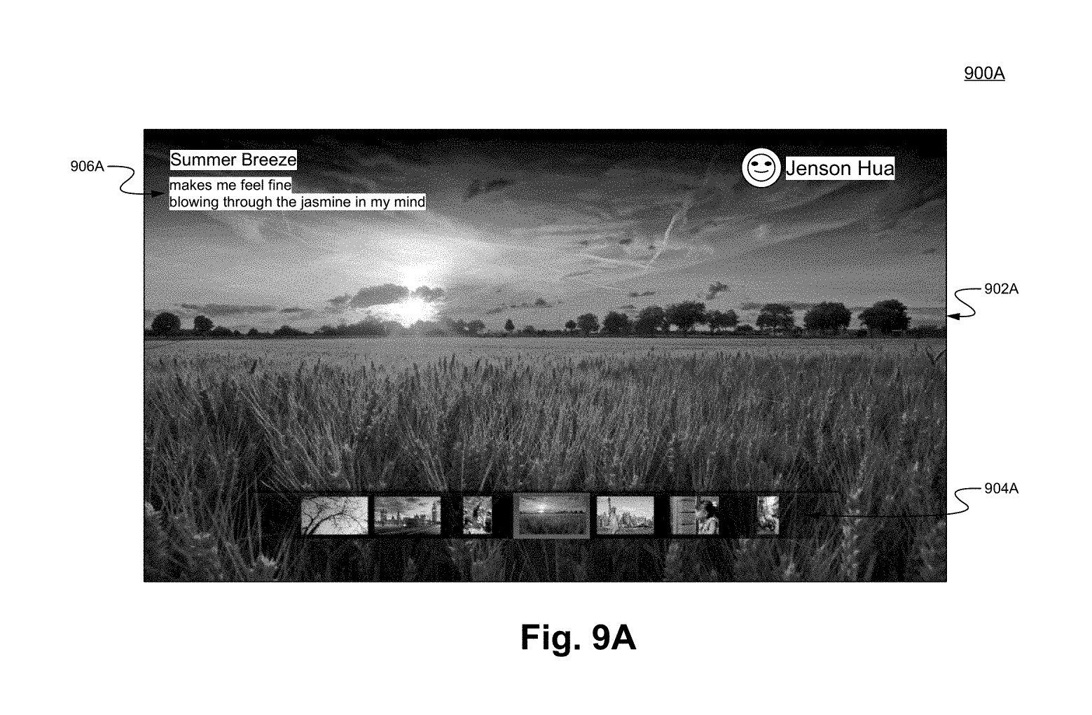

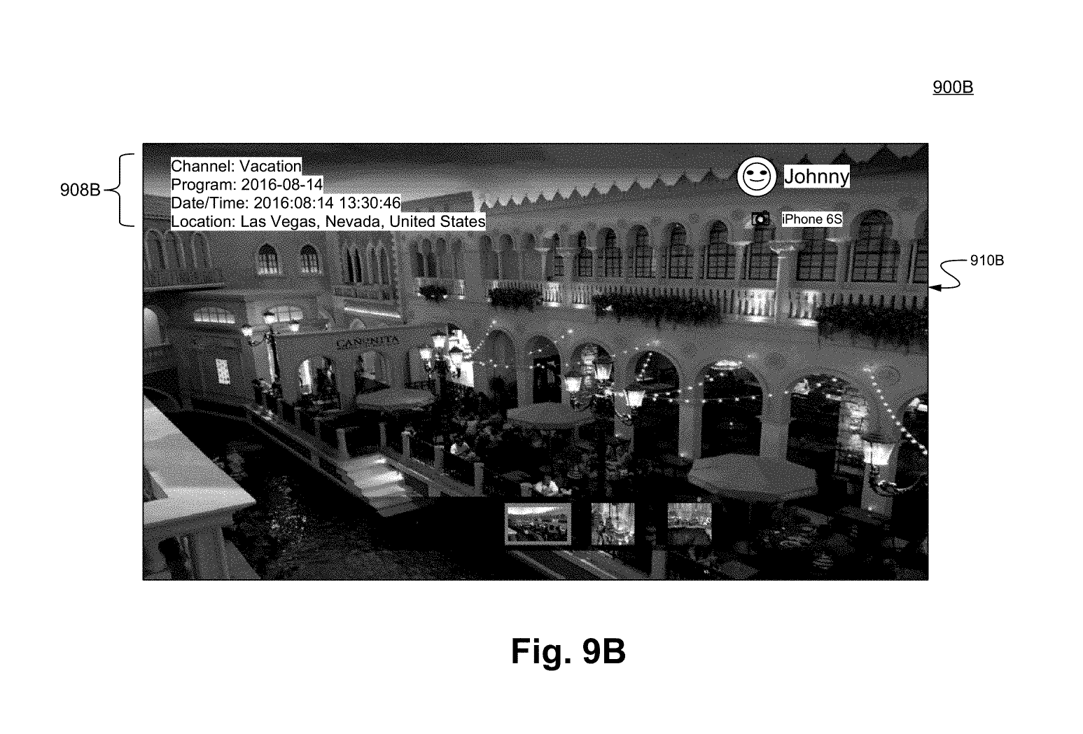

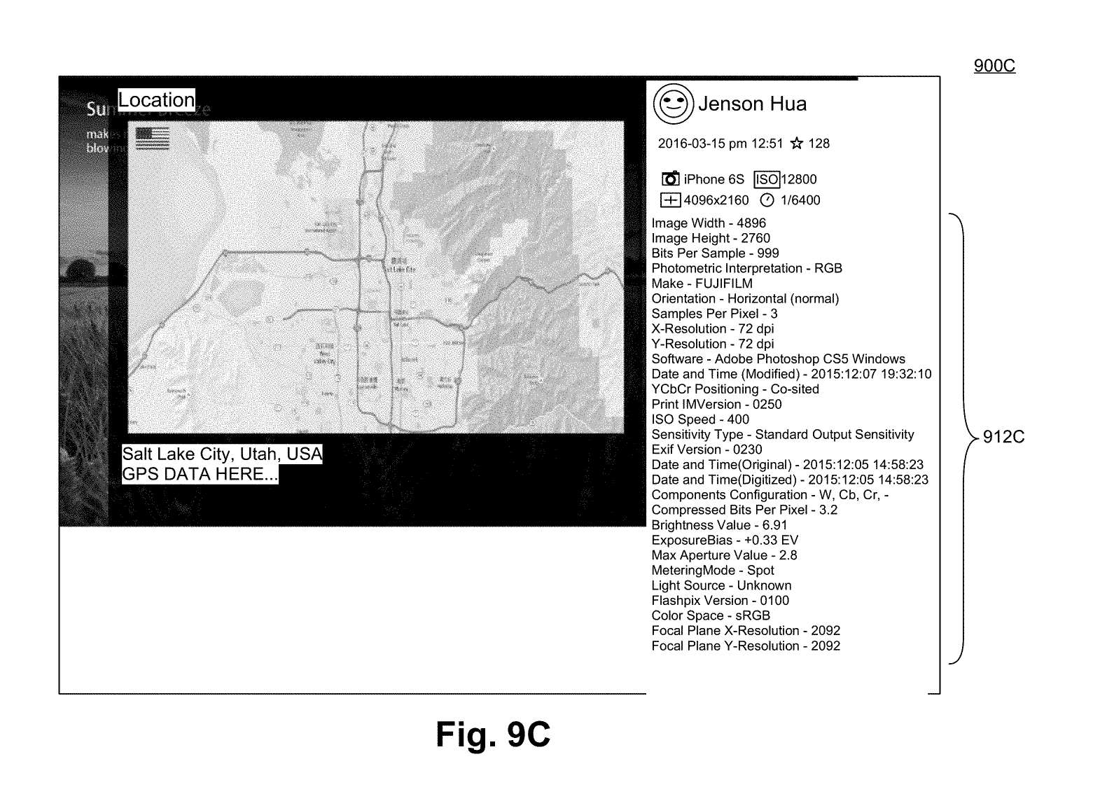

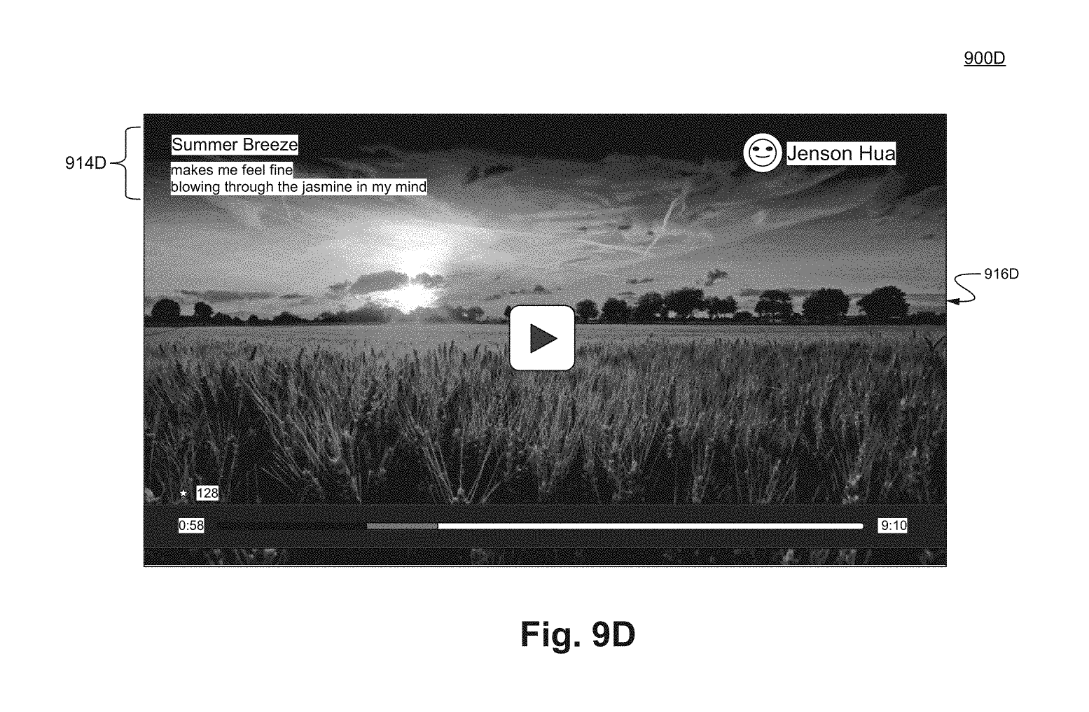

FIG. 9A illustrates a media presentation system 900A, which is in a full screen mode. The media is displayed in a full screen mode 902A with information 906A (e.g., title, user descriptions, artificial intelligence-generated captions and/or owner info) on left top of the screen. The preview panel 904A provides a preview of the upcoming next photo in the queue and previous showed media.

FIG. 9B illustrates a media presentation sorting system 900B, which is in a full screen mode. The media is displayed in a full screen mode 910B with information 908B (e.g., channel, program, date, location, user or device info) on left top of the screen.

FIG. 9C illustrates a media presentation sorting system 900C, which is in a full screen mode with detailed photo information 912C. The detailed information 912C can be displayed in an overlay detailed view, which can include locations, device, and the information recorded about the photo when it is captured.

FIG. 9D illustrates a media presentation sorting system 900D, which is in video playback format. The detailed information 914D can overlay on top of the video 916D.

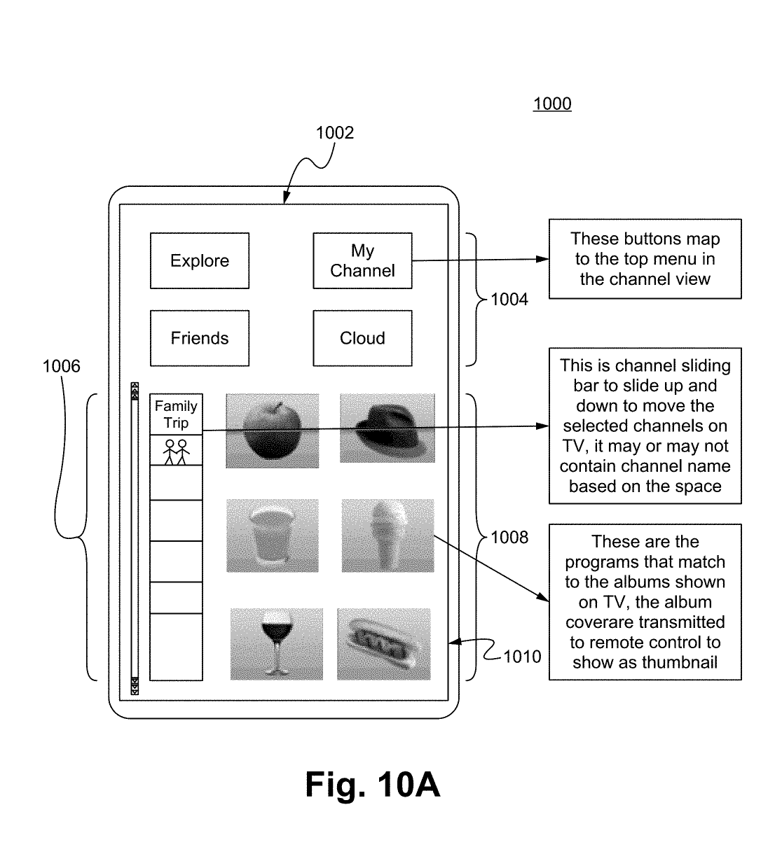

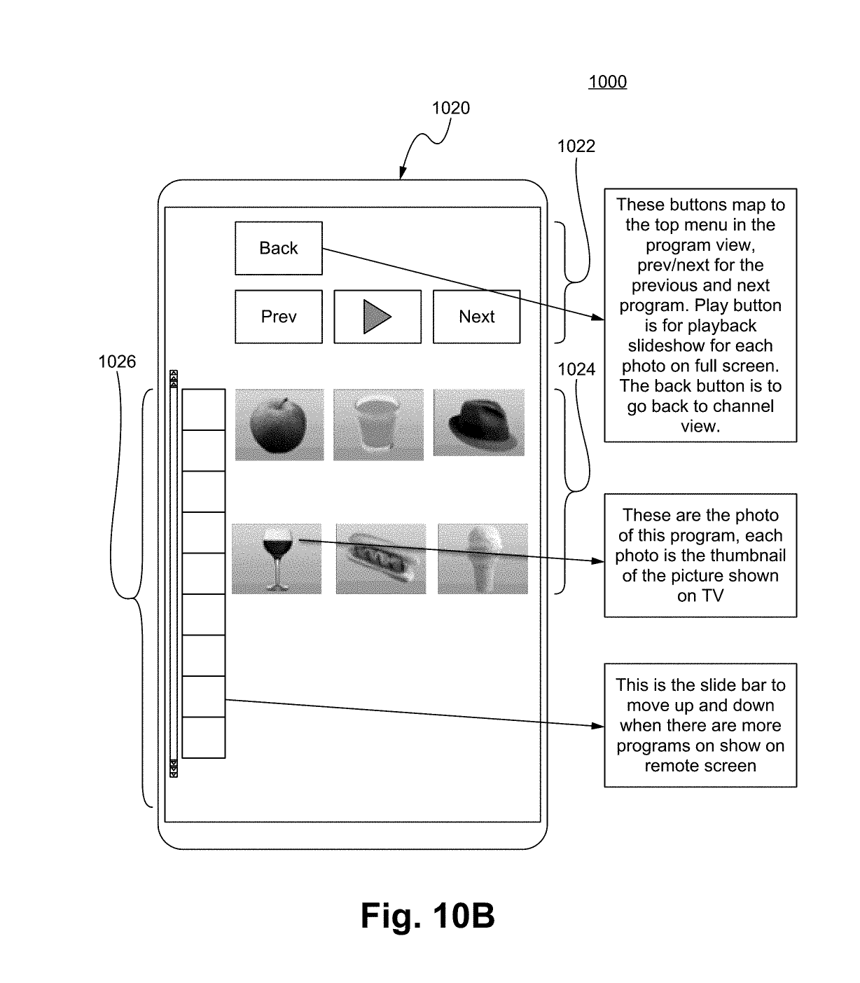

FIG. 10A illustrates a mobile control 1000 of the user interface in accordance with some embodiments. The mobile control 1000 is able to be used as TV remote control, which is able to control the Unified User Interface (UUI) on the TV via infrared or Wi-Fi signals that are received by the TV or internet router.

In a typical user interface, if channel/program arrangement is browsed through with the typical TV remote control, it would still be very difficult to use since it usually has only 4-way arrow key and numeric keys. Even with some touch based remotes from Apple TV, Roku or Amazon Fire TV, they are still not good enough.

In some embodiments, a remote control is provided to deal with a multiple focus group, left channel group and middle program group, and top menu selection in accordance with some embodiments.

In some embodiments, a touch screen based remote control contains a rectangle touch pad or remote control app on a smartphone. The user interface 1002 contains multiple regions 1004 (e.g., touch screen buttons) associated with TV screens. On the channel screen 1006, scrolling on the left pane is scrolling through the channel list up and down. Scrolling on the middle pane 1008 is scrolling through the programs up and down since this can be multiple pages. The faster the user scrolls on the remote, the faster the program moves as well. On the UUI, a user can also see the cover photo 1010 of the programs in the remote control to select the program to view. The icons on the channel screen 1006 can be thumbnail photos, illustration figures, texts, or a combination thereof.

In some embodiments, the screen layout on the touch remote control 1000 matches on TV and includes the same text and picture thumbnails that are displayed on TV. In some embodiments, the remote control 1000 contains a mobile App on smartphones or a dedicated hardware with display, touch and gesture detection. A few boxes on the top 1004 are associated with the top menu with the same name shown on the TV. The left panel is the channel 1006 lists, which contains a scroll bar for sliding up and down, faster or slower and stop when the targeted channel is selected on TV. The program thumbnails 1008 on the right bottom should be changed based on the channel selected.

FIG. 10B illustrates a use case 1020 of the mobile control 1000 in accordance with some embodiments. When a user clicks the specific channel to view, the TV screen and the remote control screen change simultaneously. The top buttons 1022 match the TV program view to control how to navigate the program or go back to channel view. The center part 1024 is the photo thumbnail of each photo on screen, on the left is the slide bar 1026 to slide up and down through the photos in this program.

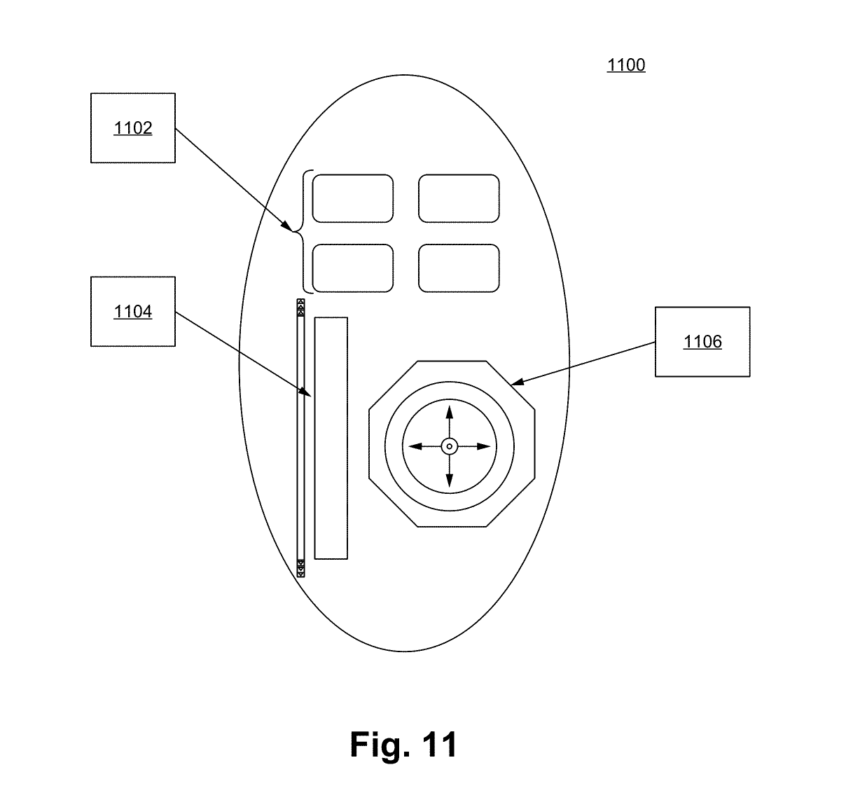

FIG. 11 illustrates a dedicated hardware remote control 1100 in accordance with some embodiments. The hardware remote control 1100 contains a top menu button 1102 to select the menu buttons from different screens. The actual number of buttons can vary. A vertical scroll bar 1104 to slide up and down, for example, in channel screen, it can be used to scroll the left channel list up and down. In the program screen, the vertical scroll bar 1104 can be used to scroll the picture page up and down. A multi-item selector 1106, which can be used to scroll to all items and press the center button to select or playback any media file.

To utilize, the media (e.g., photos and videos) are presented in channels and programs as a two layer vertical structure.

In operation, the media is acquired, one or more characteristics are associated or attributed to the media, and the media is sorted based on its characteristics. The sorting of the media can be performed before a user makes a selection, such that the media has been pre-sorted and/or reallocated in the storage location, which enhances the loading and computing efficiency by shortening the sorting time and calculation time when a selection command is made.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

What is claimed is:

1. A method of browsing and viewing personal photos and media on TV comprising:
a) receiving media files of a predetermined person from different media sources from the storage device in the local network or Internet;
b) sorting and categorizing the media files using a smart computing module that automatically generates one or more media channels and one or more media programs based on the intelligent media content analysis of at least two factors, wherein the one or more media channels forms a primary layer of a media presenting structure and one or more media programs forms a secondary layer of the media presenting structure, wherein at least one of the factors including a media content that is of the predetermined person;
c) displaying the sorted media files from various sources on a unified user interface having the one or more media channels and the one or more media programs as a media presenting structure; and
d) using a TV remote control to navigate the media presenting structure for presenting and selecting media files of interests that relates to the predetermined person.

2) The method of claim 1, wherein the sources comprises a storage device in the same local network, a remote storage device, or a cloud service.

3) The method of claim 1, further comprising displaying the media files on the unified user interface directly from one or more of the media sources, regardless if the media files are in the device itself, devices in the same local network or cloud storage, without copying and duplicating the media files at the media sources.

4) The method of claim 1, further comprising importing and displaying the media files to the unified user interface without duplicating an entirety of the media files.

5) The method of claim 4, further comprising adding the media files to an existing channel when the imported media content meets a predetermined criterion of an attribute of the existing channel.

6) The method of claim 5, further comprising recommending to a user based on the analysis of the imported media content and inquiring a permission of the user for adding the media files to the existing channel.

7) The method of claim 1, further comprising adding the media files to a created new channel when the imported media content does not match predetermined criteria of existing channels.

8) The method of claim 7, further comprising recommending a user based on the analysis of the imported media content and inquiring a permission from the user for creating the new channel.

9) The method of claim 1, further comprising manually creating new channel based on a user defined criterion.

10) The method of claim 9, further comprising using the user defined criterion for the smart computing module as a new criterion to perform subsequent sorting and categorizing of the media files.

11) The method of claim 1, further comprising generating channel using the intelligent media content analysis and media metadata extracted from the media files.

12) The method of claim 1, further comprising increasing new channels created when newly imported media meet criteria for creating a new channel

13) The method of claim 1, further comprising allowing an owner of the media files to view on the unified user interface.

14) The method of claim 13, further comprising sharing the media files to be viewed in the shared channels and programs on the unified user interface by users who have a permission.

15) The method of claim 1, further comprising dynamically creating programs for each of the channels based on one of the sorting methods that a system recommends including date, time, location, faces of people, object, theme, or a combination thereof.

16) The method of claim 15, further comprising sorting the programs using media metadata and data of the intelligent media content analysis.

17) A system for browsing and viewing personal photos on TV, comprising:
a) a receiver configured to receive media files of a person from different media sources;
b) a smart computing member configured to sort and categorize the media files and automatically generate one or more media channels and one or more media programs based on an intelligent media content analysis of at least two factors, wherein the one or more media channels forms a primary layer of a media presenting structure and one or more media programs forms a secondary layer of the media presenting structure, wherein at least one of the factors including a media content that is of the predetermined person;
c) a display configured to display the sorted media files on a unified user interface having the one or more media channels and the one or more media programs as the media presenting structure; and
d) a TV remote control configured to navigate the media presenting structure to find photos of interests.

18) The system of claim 17, wherein the receiver is configured to access sources comprises a local storage device, a remote storage device, or a cloud service.

19) The system of claim 17, wherein the smart computing member is configured to add the media files to an existing channel when the imported media content meets a predetermined criterion of the existing channel.

20) The system of claim 17, wherein the smart computing member is configured to add the media files to a created new channel when the imported media content does not match predetermined criteria of existing channels.

21) The system of claim 17, wherein the smart computing member is configured to manually create new channel based on a user defined criterion.

22) The system of claim 17, wherein the smart computing member is configured to use the user defined criterion for the smart computing module as a new criterion to perform subsequent sorting and categorizing of the media files.

23) The system of claim 17, wherein the smart computing member is configured to generate channel using the intelligent media content analysis and media metadata extracted from the media files.

24) The system of claim 17, wherein the smart computing member is configured to increase new channels created when newly imported media meet criteria for creating a new channel.

25) The system of claim 17, wherein the smart computing member is configured to allow an owner of the media files to view on the unified user interface.

26) The system of claim 17, wherein the smart computing member is configured to share the media files to be viewed in the channels and programs on the unified user interface by users who have a permission.

27) The system of claim 17, wherein the smart computing member is configured to dynamically create programs for each of the channels based on one of the sorting methods that a system recommends including date, time, location, faces of people, object, theme, or a combination thereof.

28) A device for browsing and viewing personal photos on TV, comprising:
a) a device coupled to a TV display containing a smart software with a unified user interface, wherein the unified user interface is structured to contain a list of media channels and programs, wherein the smart software is configured to categorize personal photos or videos into the channels of similar attributes, wherein the smart software is configured to further sort the personal photos and videos in each of the channel into organized programs; and
b) a remote controller controlling the device, which is configured to interact with the device for navigating the unified user interface, as well as receive information of the channels and programs from the TV display and display the information of the channels and programs on the remote controller accordingly.

29) The device of claim 28, wherein the device comprises one or more of a TV, smart TV apps and dedicated hardware device.

30) The device of claim 28, wherein the device is further configured to render unified user interface on the television display and controlled through the remote controller.

31) The device of claim 28, further comprising a smart computing module configured to utilize hardware or software to perform media sorting and categorizing.

32) The device of claim 28, wherein the remote controller comprises a smart app running in a smart telephone or mobile device with channel scrolling and multiple direction selector for channel and program navigation.

33) The device of claim 28, wherein the remote controller comprises a dedicated hardware device with channel scrolling and multiple direction selector for channel and program navigation.
